(19) United States
(12) Patent Application Publication
(10) Pub. No.: US 2012/0081067 A1
(43) Pub. Date: Apr. 5, 2012

(54) UNIVERSAL CHARGING CORD WITH AN ILLUMINATED SOCKET END

(76) Inventor: James W. Burrell, IV, Union, NJ (US)

(21) Appl. No.: 12/946,272

(22) Filed: Dec. 9, 2010

Related U.S. Application Data
(60) Provisional application No. 61/388,653, filed on Oct. 1, 2010.

(51) Int. Cl. H02J 7/00

(52) U.S. Cl. 320/107

(57) ABSTRACT

A universal charger with an illuminated socket end is disclosed. The illumination source may be internally or externally powered from either end. Exchangeable charging plugs and sockets power and charge all mobile devices including: 12V DC to one of thirteen AC outlets, a secondary illumination source, a splitter socket plug, a male or female charging plug, a powered communications charging plug or socket, etc. A multi-voltage regulator with a voltage indicator provides exact voltages for specific devices. One of thirteen AC to DC charging adapters allows the charger to be plugged into any AC outlet in the world. A magnetic clip allows the illuminated socket end to be clipped on a visor or placed in any location for hands-free aiming of the illumination source. A cable with removable plug and socket ends allows multiple length charger cords, plug tips, plug sockets, DC to AC outlets, AC to DC adapters, etc.

### RELATED APPLICATION

This application claims priority to and is a continuation in part of U.S. Provisional Patent Application No. 61/388,653, filed Oct. 1, 2010.

### FIELD OF THE INVENTION

The present invention relates to portable chargers for mobile devices having a light source readily available, and more particularly to multi-functional portable chargers for powering and charging all devices using any and all types of DC or AC electrical sockets and plugs found throughout the world.

### BACKGROUND OF THE INVENTION

Mobile charging cords are designed to be inserted in a cigarette lighter outlet.

Cigarette lighter outlets provide a 12+ volt maximum, 15 amp power supply within a vehicle. 12V power fluctuates from 12.5V when not charging to around 14.5V when the alternator is charging and can drop to 5V-6V when the engine is started. DC to DC converters compensate for the fluctuations. Trucks use a 24V electrical system. Aircraft use a 28V electrical system. Most vehicles have only one cigarette lighter outlet. DC charging cords use this power supply to power and charge mobile devices, portable electronic devices, PDAs, lights, fans, heating devices, coolers, motorized tools, music players, cell phones, vacuum, etc.

U.S. 12V automobile plugs use the “UL2089” standard. Sockets and plugs are defined in the ANSI/SAE J563 specification. Spec J563 describes the socket as a cigar lighter. The “cigar” lighter plug's contact point has a positive voltage and the outer part has a negative voltage. The U.S. size A 12V cigar lighter socket has an inside diameter of 20.93 mm-21.01 mm and the plug has a diameter of 20.73 mm-20.88 mm. The European size B 12V cigar lighter socket has an inside diameter of 21.41 mm-21.51 mm and the plug has a diameter of 21.13 mm-21.33 mm.

Different mobile devices have different charging voltages and different charging tips, plugs and sockets. When charging different types of cellular phones or mobile devices, a different charging cord is usually required for each device. An exact charging voltage and charging connection (plug or socket) is required for each specific device.

When connecting a charging cord to a device at night, it is difficult to see the connection port while inserting the plug into the device and the orientation of the plug end for insertion into the device. Charging cords are used often in a vehicle and are usually left in plain sight. Flashlights are usually left in the glove box or trunk. At night, if a right-handed driver, when seated in the driver seat, uses the overhead light to illuminate the car interior while they are writing something, the right hand produces a shadow over what they are writing, making it difficult to see what they are writing. Changing a tire or performing some other type of action alone at night requires a third hand to hold a flashlight. The multitude of electric outlets found throughout the world in residential or commercial locations use different voltages, different hertz current (cycles per second) and require different adapter plugs for a device to work using a voltage or hertz current it was not designed to be powered or charged with.

The present invention addresses the above identified problems by providing multiple embodiments which independently or all together eliminate these problems.

### SUMMARY OF THE INVENTION

Accordingly, the present invention comprises methods and apparatuses for providing an illumination source while using a multi-functional charging cord or cigarette lighter charging cord to power and charge all devices. The preferred charging cord includes a cable with at least two wires, a standard voltage or multi-voltage regulator cigarette lighter plug on one end for insertion into a cigarette lighter power supply outlet for converting the supplied power voltage into the required DC voltage, and a socket connecting means on an opposite end with preferably at least one illumination source preferably facing outward on or in the socket housing. The standard voltage or multi-voltage regulator plug end also can also include an AC outlet DC conversion plug socket for plugging the charging cord into any AC voltage power source. The multi-voltage regulator embodiment provides DC voltages ranging from 1 volt to 12+ volts, depending on the continuous and maximum voltage output of the cigarette lighter socket or the AC voltage plug outlet DC voltage conversion socket. Some of the standard battery voltages for mobile device batteries are 1.5V, 2.4V, 2.5V, 3V, 3.6V, 3.7V, 4.5V, 5V, 6V, 7.2V, 7.4V, 7.5V, 9V, 9.6V, 10V, 12V, 12-24V, etc. Batteries are usually charged with a 1V to 2V increased voltage than the voltage output of the battery. A 3.6V or 3.7V cellular phone battery is usually charged at around 5V. A vehicle alternator charges a 12V battery at around 14V to 15V. A cigarette lighter socket may provide more than 12V of power produced by a vehicle's alternator. The illumination source on or in the socket end housing can be turned on or off and may be powered internally or by the connected device. In the multi-voltage regulator embodiment, a third wire can power the illumination source independently. Multiple types of plug tips or socket tips for insertion into the illumination source socket end housing can be interchanged for powering and charging every type of device. Charging plugs and sockets include and are not limited to a two or three prong AC outlet plug (only U.S. 110V-120V shown), a secondary illumination source plug, a two or more cigarette lighter socket splitter plug, a male charging tip plug, a female charging tip plug, a communications charging tip plug, a communications socket plug, etc. Another embodiment includes an illumination source located on the outer housing of the cigarette lighter plug, letting a user know when it is plugged in and when the charge is complete. Further, exemplary embodiments include an illuminated multi-voltage regulator display for showing the voltage supplied to the illumination source socket end connecting means.

Using the preferred embodiment shown in FIG. 1B, allows replacing either end of the charging cord with any type of powering or charging means. DC voltage to AC voltage converters or AC voltage to DC voltage converters include Type A, Type B, Type C, Type D, Type E, Type F, Type G, Type H, Type I, Type J, Type K, Type L and Type M plugs or outlets including 110V, 115V, 120V, 127V, 150V, 160V, 175V, 220V, 230V, 231V, 240V, 250V, 280V, etc. AC voltages and 40 Hz, 50 Hz or 60 Hz AC power frequencies. The disclosed embodiments will allow any type of device or any type of power source to power or charge any type of device.

A multitude of modifications and enhancements can be made to the methods and apparatuses for providing an illumination source while using a multi-functional charging cord or cigarette lighter charging cord for powering and charging all devices without departing from the spirit and scope of the invention as a whole.

To provide a further understanding of the invention, the foregoing general description, the following detailed description and the accompanying drawings are exemplary (included only for illustration of the invention), and are intended to provide further explanation of the multiple embodiments of the present invention as claimed. These and other objects, features and advantages of the present invention will be better understood in connection with the following drawings and descriptions of the preferred embodiments.

### BRIEF DESCRIPTION OF THE DRAWINGS

The accompanying drawings provide a further understanding of the invention, and are incorporated in and constitute a part of this specification. The drawings illustrate preferred embodiments of the invention, and together with the description, serve to explain the principles of the invention. A brief introduction of the drawings is as follows:

FIG. 1A illustrates an exemplary multi-functional cigarette lighter charging cord according to one embodiment of the present invention.

FIG. 1B illustrates an exemplary multi-voltage cigarette lighter charging cord assembly according to another embodiment of the present invention.

FIG. 2A illustrates an exemplary top view of the socket for the multi-functional cigarette lighter charger of FIG. 1.

FIG. 2B illustrates an exemplary side view of the socket for the multi-functional cigarette lighter charger of FIG. 1.

FIG. 2C illustrates an exemplary frontal view of the socket for the multi-functional cigarette lighter charger of FIG. 1.

FIG. 3A illustrates an exemplary frontal view of a Type A 120V 60 Hz two-prong polarized inverter plug for insertion into the socket of FIG. 2C.

FIG. 3B illustrates an exemplary side view of a Type A 120V 60 Hz two-prong polarized inverter plug for insertion into the socket of FIG. 2C.

FIG. 4A illustrates an exemplary frontal view of a Type B 120V 60 Hz three-prong inverter plug for insertion into the socket of FIG. 2C.

FIG. 4B illustrates an exemplary side view of a Type B 120V 60 Hz three-prong inverter plug for insertion into the socket of FIG. 2C.

FIG. 5A illustrates an exemplary frontal view of a honeycomb arranged LED flashlight for insertion into the socket of FIG. 2C.

FIG. 5B illustrates an exemplary side view of a LED flashlight for insertion into the socket of FIG. 2C.

FIG. 6A illustrates an exemplary frontal view of a cigarette lighter outlet splitter for insertion into the socket of FIG. 2C.

FIG. 6B illustrates an exemplary side view of a cigarette lighter outlet splitter for insertion into the socket of FIG. 2C.

FIG. 7A illustrates an exemplary side view of a male plug for insertion into the socket of FIG. 2C.

FIG. 7B illustrates an exemplary back view of a male plug for insertion into the socket of FIG. 2C.

FIG. 8A illustrates an exemplary side view of a female plug for insertion into the socket of FIG. 2C.

FIG. 8B illustrates an exemplary back view of a female plug for insertion into the socket of FIG. 2C.

FIG. 9A illustrates an exemplary side view of a USB plug or socket for insertion into the socket of FIG. 2C.

FIG. 9B illustrates an exemplary back view of a USB plug or circuit for insertion into the socket of FIG. 2C.

### LIST OF REFERENCE NUMBERING

5 shows a male electrical connection.
10 shows a female electrical connection.
11 shows a recessed outlet for receiving a plug module.
15 shows a plug end of a plug module for insertion into a socket.
20 shows a Type A 120V 60 Hz two-prong electrical outlet plug module.
25 shows a Type A 120V 60 Hz two-prong electrical outlet.
30 shows a Type B 120V 60 Hz three-prong electrical outlet plug module.
35 shows a Type B 120V 60 Hz three-prong electrical outlet.
40 shows flashlight plug module.
45 shows an illumination source (preferably LEDs).
50 shows a dual cigarette lighter outlet splitter plug module.
55 shows a cigarette lighter outlet.
60 shows a male electrical connector plug module.
65 shows a male electrical connector.
70 shows a female electrical connector plug module.
75 shows a female electrical connector.
80 shows an electrical communications plug or socket connector plug module.
85 shows an electrical communications plug or socket connector.
100 shows a universal charging cord with light on connecting outlet socket port assembly.
110 shows a coiled electrical cable.
115 shows a detachable coiled electrical cable.
120 shows a cigarette lighter plug.
130 shows a cigarette lighter plug first electrical tip.
135 shows two cigarette lighter plug second electrical contact springs.
140 shows a connecting outlet socket port with an illumination source.
150 shows an on/off switch.
155 shows an illumination source.
200 shows a universal charging cord assembly with a detachable charging cable 115 connected to a preferable cigarette lighter plug on one end and a connecting socket port with an illumination source on an opposite end.
210 shows an electrical connecting means.
220 shows a cigarette lighter plug with a means of adjusting the voltage supplied to the connecting outlet socket port.
230 shows a voltage display.
240 shows a means of increasing voltage supplied to the connecting outlet socket port.
250 shows a means of decreasing voltage supplied to the connecting outlet socket port.

### DETAILED DESCRIPTION OF THE INVENTION

Wherever possible in the following description, like reference numerals will refer to like elements and parts, unless otherwise illustrated. It will be apparent to one skilled in the art that well known features have not been described in detail to avoid obscuring the multiple embodiments of the invention. Additional objects of the present invention will become apparent as the description proceeds.

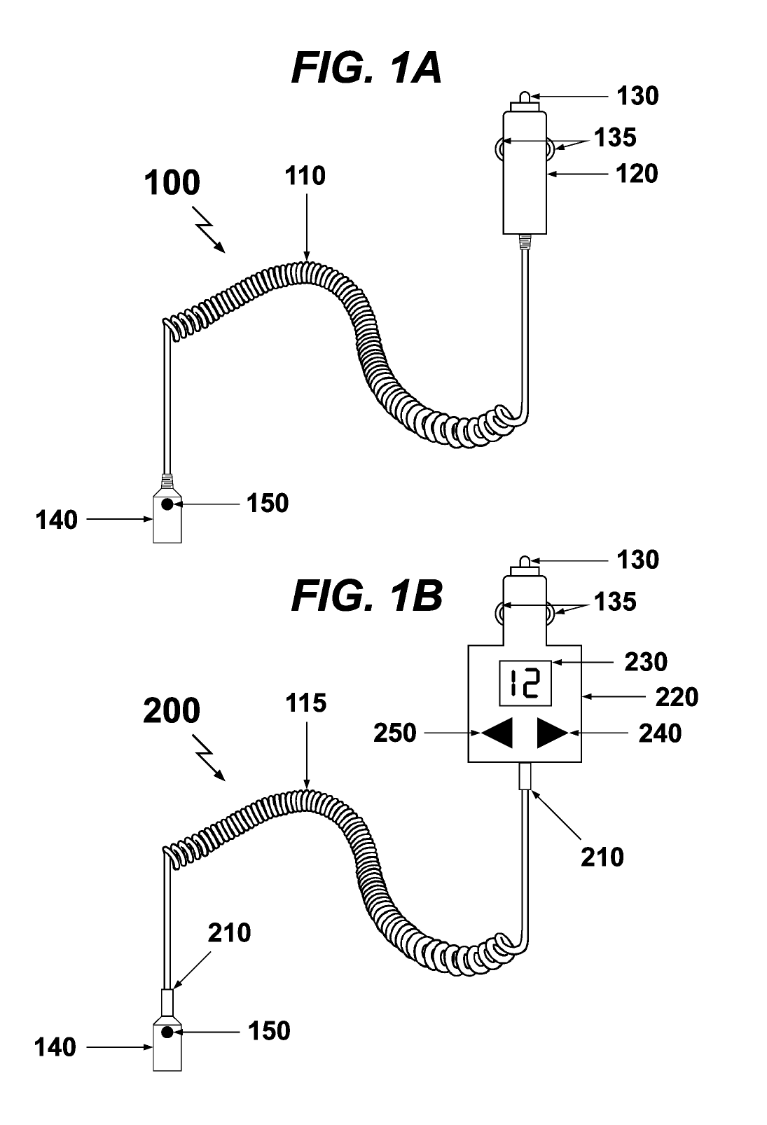

FIG. 1A illustrates an exemplary cigarette lighter charger 100 according to the present invention. The cigarette lighter charger 100 comprises a cable 110 with at least two wires for electrically connecting a cigarette lighter plug 120 with a specific DC voltage output comprising a first electricity contact tip 130 and second electricity contact springs 135 for insertion into a cigarette lighter socket power supply and an opposite outlet socket port 140 end with an illumination source 155 directionally located on or in the housing which can be turned on or off with a switch 150. The cable 110 may also include a third wire for independently powering the illumination source 155 with the required voltage. The switch 150 may comprise a conventional on/off switch or any other type of switch (push-button, rocker, slide, membrane, key, etc.) known in the art. The cigarette lighter plug 120 end may also include an internal power supply (battery/capacitor not shown) and a fuse (not shown) to protect the device being powered or charged. The cigarette lighter charger 100 with an internal power supply, an illumination source 155 and a switch 150 for turning the illumination source 155 on or off, allows the cigarette lighter charger 120 or assembly to be taken out of the cigarette lighter outlet and used as a flashlight. The cigarette lighter plug 120 preferably includes a prior art secondary illumination source (not shown) to notify the used when the charger is powered and when the charge cycle is completed. The cigarette lighter plug 120 also includes a DC to DC adapter for converting the external DC voltage to the required supplied DC voltage.

FIG. 1B illustrates an exemplary cigarette lighter charger assembly 200 according to the present invention. The cigarette lighter charger assembly 200 comprises a detachable cable 115 with electrical connectors 210 on either end for electrically connecting a detachable cigarette lighter plug 220 comprising a first electricity contact tip 130 and second electricity contact springs 135 for insertion into a cigarette lighter socket power supply or a secondary predetermined or adjustable power source, and an opposite end comprising a detachable outlet socket port 140 with an externally or internally powered illumination source 155 which can be turned on or off with a switch 150, or a secondary detachable socket or plug. The cable 110 may also include a third wire for independently powering the illumination source 155 socket end. The detachable cable 115 may also comprise a retractable cable enclosed in a housing (not shown) for increased length and compactness, which is commonly known in the art. The switch 150 may comprise a conventional on/off switch or any other type of switch (push-button, rocker, slide, membrane, key, etc.) known in the art. The cigarette lighter plug 220 preferably comprises an illuminated voltage display 230 and a means of increasing 240 or decreasing 250 the voltage supplied to the connecting outlet socket port 140 end. The means of increasing 240 or decreasing 250 the voltage may comprise a conventional on/off switch(s) or any other type of switch(s) (dial, push-button, rocker, slide, membrane, key, etc.) known in the art. The cigarette lighter plug 220 may also include an internal power supply (battery/capacitor not shown) and a fuse (not shown) to protect the device being powered or charged. The cigarette lighter plug 220 end may also be replaced with a standard voltage cigarette lighter plug 120 supplying a standard non-changing voltage to the connecting outlet socket port 140 end. The cigarette lighter plug 220, with or without a voltage regulator, comprising an internally powered illumination source 155 (not shown) and a switch 150 for turning the illumination source 155 on or off, allows the cigarette lighter plug 220 to be taken out of the cigarette lighter outlet and used as a flashlight. The cigarette lighter plug 220 preferably includes a prior art secondary illumination source (not shown) to notify the used when the charger is powered and when the charge cycle is completed. The cigarette lighter plug 220 illuminated voltage display 230 may also display the voltage supplied by the cigarette lighter socket.

The cable 110 or detachable cable 115 may comprise a coiled cord or a retractable cord capable of using a 12V DC or a 24V DC power source.

The cigarette lighter plug 220 end may also be replaced with a communications connector (5V USB, 5V HDMI, 12V FireWire, etc.) plug tip for insertion into a communications port for providing power to the connecting outlet socket port 140 end or detachable cable 115 connection end 210. The communications connector (5V USB, 5V HDMI, 12V FireWire, etc.) may also include a power regulator (not shown) for changing the DC voltage supplied to the connecting outlet socket port 140 end or detachable cable 115 end 210. The cigarette lighter plug 220 may include a solar panel (not shown) attached or embedded on one side of the housing or may also be replaced with a 5V, 6V or 12V or 24V solar panel (not shown) for solar charging of a device. The cigarette lighter charger assembly 200 shown and described enables any device to power any other device. When voltage values at either end of the detachable cable 115 do not match, a power inverter may be included in one of the plug or socket ends. The detachable cable 115 with electrical connectors 210 on either end may also be used to power the illumination source 155 on one end by connecting the opposite end to a cell phone or mobile device.

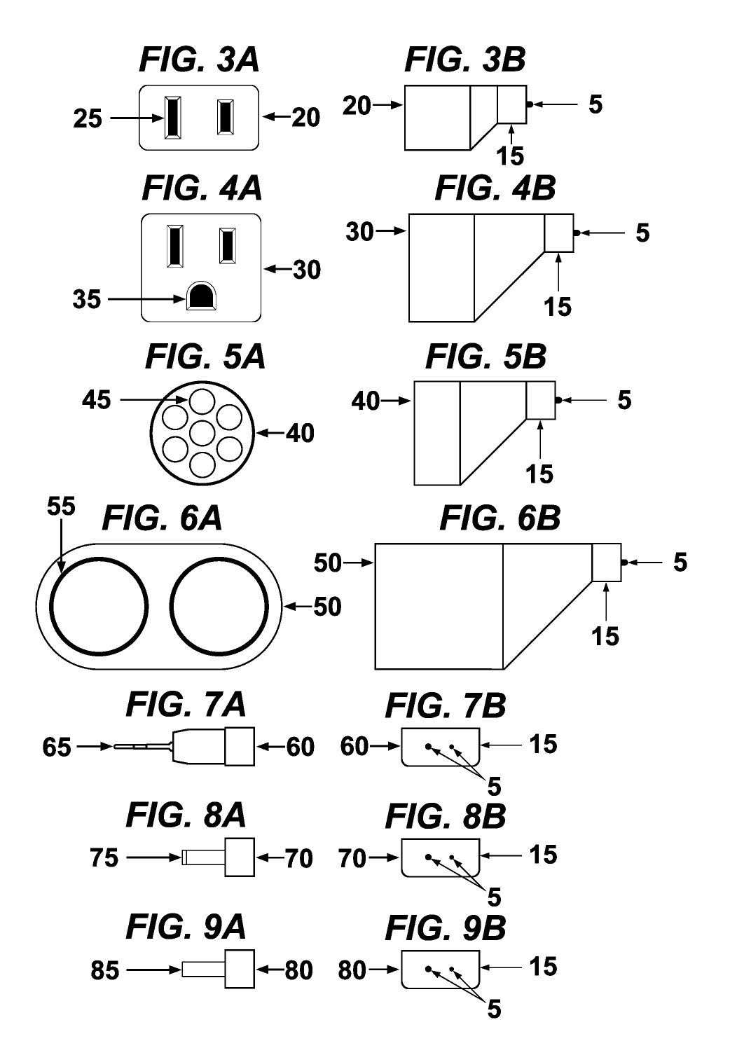

Those skilled in the art will appreciate that cigarette lighter chargers comprise a wide variety of mobile device plugs or sockets 20 to 80, etc. and a multitude of types of cigarette lighter power plugs 120 and 220, etc. with different voltage outputs. As such, the present invention is not limited to the specific mobile device plugs or sockets 20 to 80 shown in FIGS. 3A-9B or the DC power plugs 120 and 220 shown in FIGS. 1A-1B.

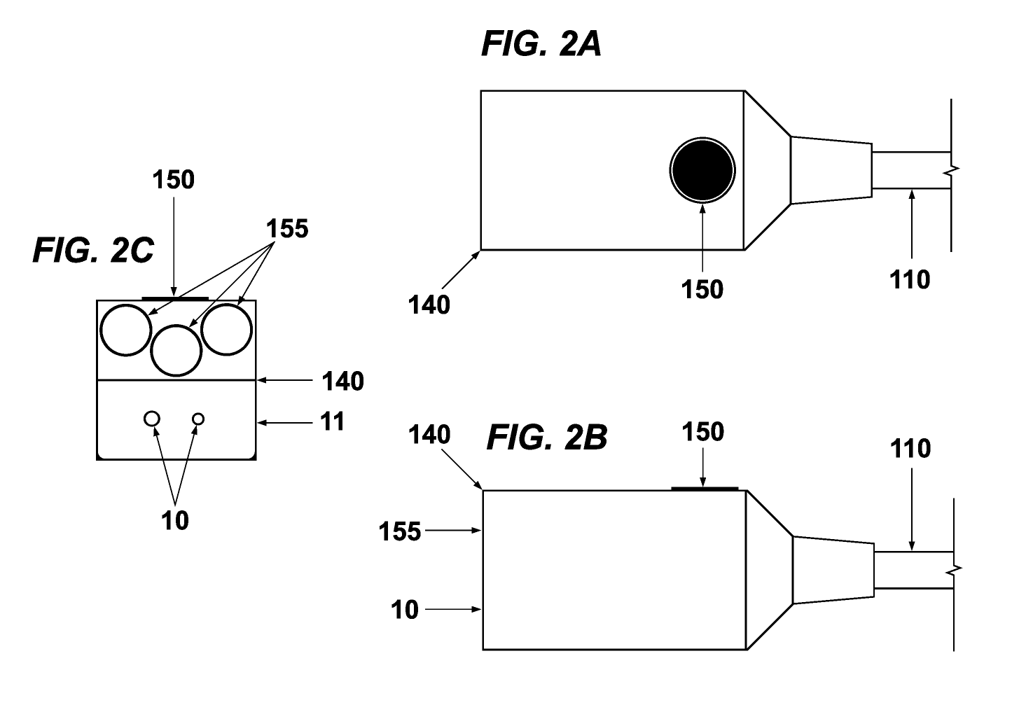

As shown in FIG. 2A, the connecting outlet socket port with an illumination source 140 top view comprises an outer housing connected to a cable 110 with a switch 150 for turning the illumination source 155 on or off. In FIG. 2B, the connecting outlet socket port with an illumination source 140 side view comprises an outer housing connected to a cable 110 with a switch 150 for turning the illumination source 155 on or off. The recessed illumination source 155 may comprise any type of light source known in the art, but preferably comprises at least one light emitting diode (LED), preferably rated at 50,000 hours of continuous use and having a high lumen value. Using a switch 150 capable of increasing or decreasing the voltage supplied to the illumination source 155 (not shown) allows the user the ability to adjust the lumen output of the illumination source 155. The recessed outlet 11 for receiving a plug module includes a preferred female electrical connection 10. In FIG. 2A or 2B, the cable connection may also include a removable electricity connecting means 210. One side of the connecting outlet socket port with an illumination source 140 may also include a magnet embedded in the housing (not shown) and an embedded or removable internal power source (not shown).

As shown in FIG. 2C, the connecting outlet socket port with an illumination source 140 front view comprises an outer housing with a switch 150 for turning the illumination source 155 on or off. The recessed illumination source 155 includes at least one light source. The illumination source 155 may comprise any type of light source known in the art, but preferably comprises at least one light emitting diode (LED) as shown. The recessed outlet 11 for receiving a plug module includes a female electrical connection 10. The female electrical connection 10 shown preferably comprises two electrical connections, but may also comprise a mono electrical connector means shown in FIG. 7A, also known in the art as a telephone jack or plug.

FIG. 3A illustrates an exemplary frontal view of a Type A 120V 60 Hz two-prong plug 20 with a polarized two-prong AC outlet 25 and a plug end 15 for insertion into the socket 11 of FIG. 2C. FIG. 3B illustrates an exemplary side view of a Type A 120V 60 Hz two-prong plug 20 and a plug end 15 for insertion into the socket 11 of FIG. 2C. The cable connection may also include a removable electricity connecting means 210. FIG. 4A illustrates an exemplary frontal view of a Type B 120V 60 Hz three-prong plug 30 with a three-prong AC outlet 35 and a plug end 15 for insertion into the socket 11 of FIG. 2C. FIG. 4B illustrates an exemplary side view of a Type B 120V 60 Hz three-prong plug 30 and a plug end 15 for insertion into the socket 11 of FIG. 2C. Other AC outlet configurations (2-pin round European plug, etc.) used throughout the world are not shown, but are implied as the present invention's other AC outlet connecting means and include the AC plugs found throughout the world including: Type C, Type D, Type E, Type F, Type G, Type H, Type I, Type J, Type K, Type L and Type M. The cable connection may also include a removable electricity connecting means 210.

The inverter housings, shown in FIGS. 3A-4B, are smaller than the actual dimensions required to encase the circuitry for converting a 12V or 24V DC power source into an AC voltage power source with 40 Hz, 50 Hz or 60 Hz frequencies and 110V, 115V, 120V, 127V, 150V, 160V, 175V, 220V, 230V, 231V, 240V, 250V, or 280V AC voltages. Another embodiment (not shown) includes plugging the electrically connecting cigarette lighter plug 120 or 220 into a prior art 12V or 24V DC power cigarette lighter socket AC to DC rectifier wall plug adapter powered by a 110V, 115V, 120V, 127V, 150V, 160V, 175V, 220V, 230V, 231V, 240V, 250V, or 280V AC power source with 40 Hz, 50 Hz or 60 Hz frequency power. Alternatively, the electrically connecting cigarette lighter plug 120 or 220 can be replaced with a 40 Hz, 50 Hz or 60 Hz frequency/110V, 115V, 120V, 127V, 150V, 160V, 175V, 220V, 230V, 231V, 240V, 250V, 280V, etc. AC to DC transformer charging plug (not shown) having a standard DC voltage output or a multitude of adjustable DC charging voltages. The AC to DC transformer charging plugs (not shown) also include AC plugs for voltages found in the U.S.A. (Type A and Type B) and throughout the world (Type C, Type D, Type E, Type F, Type G, Type H, Type I, Type J, Type K, Type L and Type M). Many 220V countries have converted or are in the process of converting to the EU 230V standard. Electrical wiring and electric plugs differ from country to country. If a device uses a different kind of plug power, an electrical transformer is usually necessary. Most electrical power systems are prone to slight variations in electrical voltage.

Type A plug is a 2-blade electrical plug: NEMA 1-15 (North American 15 A/125V ungrounded/polarized) or JIS C 8303, Class II (Japanese 15 A/100V ungrounded/non-polarized); Type B plug is a 2-blade electrical plug with a round grounding or earth pin: NEMA 5-15 (North American 15 A/125V grounded); Type C plug is a two-pin unearthed electrical plug: CEE 7/16 (Europlug 2.5 A/250V unearthed and fit in most Type C-E-F-H, and some Type L sockets) or the larger CEE 7/17 has a round plastic or rubber base; Type D plug has three large round pins in a triangular configuration: BS 546 (5 A/250V earthed); Type E plug has two round pins spaced 19 mm apart, with a hole for the socket's male grounding pin and the live connection on the left and the neutral connection on the right (Type E sockets will also accept Type C plugs, and Type E plugs will also work in Type F sockets); Type F plug has two earth clips on the side rather than a female earth contact (Type F socket will accept Type C and Type E plugs); Type G plug is a British three-pin rectangular blade plug that has a protective fuse inside to protect cords from high current circuits: BS 1363 (British 13 A/230-240V 50 Hz earthed and fused); Type H plug has three pins in triangular formation: Israeli (16 A/250V unearthed); Type I plug has two flat oblique blades forming an inverted V and a grounding blade: (AS/NZS plug variants include 15 A, 20 A, 25 A and 32 A); Type J plug is known as the Swiss 3-Pin with an earth pin off to one side and the Swiss socket can accept Type C plugs: SEV 1011 (Swiss 10 A/250V); Type K plug has two round pins and a spade grounding pin: (Danish 10 A/250V unearthed); Type L plug has two round pins and a round grounding pin all in a line: (CEI 23-16/VII); Type M plug has three circular pins and is larger than the Type D plug: BS 546 (South African 15 A/250V).

FIG. 5A illustrates an exemplary frontal view of a LED flashlight 40 with seven

LED illumination sources 45 arranged in a honeycomb formation and a plug end 15 for insertion into the socket 11 of FIG. 2C. More LED illumination sources 45 increase the size of the LED flashlight 40 and the amount of available light. FIG. 5B illustrates an exemplary side view of a LED flashlight 40 for insertion into the socket of FIG. 2C. The cable connection may also include a removable electricity connecting means 210.

FIG. 6A illustrates an exemplary frontal view of a cigarette lighter outlet splitter 50 with at least two cigarette lighter sockets 55 and a plug end 15 for insertion into the socket 11 of FIG. 2C. FIG. 6B illustrates an exemplary side view of a cigarette lighter outlet splitter 50 and a plug end 15 for insertion into the socket 11 of FIG. 2C. The cable connection may also include a removable electricity connecting means 210.

FIGS. 3A, 3B, 4A, 4B, 6A and 6B all use a preferable 12V or 24V power source.

FIG. 7A illustrates an exemplary side view of a male plug 60 with a male plug tip 65 (known in the art as a mono or stereo telephone charging tip plug) and a plug end 15 for insertion into the socket 11 of FIG. 2C. FIG. 7B illustrates an exemplary back view of a male plug 60 and a plug end 15 for insertion into the socket 11 of FIG. 2C. The cable connection may also include a removable electricity connecting means 210.

FIG. 8A illustrates an exemplary side view of a female plug 70 with a female plug tip 75 and a plug end 15 (known in the art as a coaxial power connector, barrel connector, concentric barrel connector, etc.) for insertion into the socket 11 of FIG. 2C. FIG. 8B illustrates an exemplary back view of a female plug 70 and a plug end 15 for insertion into the socket 11 of FIG. 2C. The cable connection may also include a removable electricity connecting means 210.

FIG. 9A illustrates an exemplary side view of a communications (USB, HDMI, FireWire, Mini-USB, Micro-USB, etc.) plug or socket 80 with a plug tip 85 and a plug end 15 for insertion into the socket 11 of FIG. 2C. FIG. 9B illustrates an exemplary back view of a communications plug or socket (jack, outlet, etc.) 80 and a plug end 15 for insertion into the socket 11 of FIG. 2C. Although most battery powered computers (laptops, netbooks, etc.) use a power supply exceeding 12V, they will accept a 12V or a 5V charge. The USB tip plug or socket 80 shown in FIG. 9A may comprise a USB tip plug or socket, HDMI tip plug or socket, FireWire tip plug or socket, mini-USB tip plug or socket, a micro-USB tip plug or socket, laptop charging tip plug or socket, netbook charging tip plug or socket, handheld game charging tip plug or socket, PDA charging tip plug or socket, 1.3 mm, 1.7 mm, 2.1 mm, 2.5 mm, 3.5 mm, ¼″, miniature ⅛″, and subminiature 3/32″ mono and stereo telephone charging tip plug or socket, DC coaxial power connector, also known as barrel connectors, concentric barrel connectors or tip connectors, charging tip plug or socket, dual banana (preferably 2 pin plugs having pins that are 1.5 mm in diameter, 6 mm long and spaced 4.2 mm apart) charging tip plug or socket, the 15V, 75 W EmPower™ (aircraft power adapter) plug or socket, or any charging tip plug or socket required to charge any device manufactured by Acer™, Apple™, ASUS™, AudioVox™, Compaq™, Dell™, Fujitsu™, Gateway™, HP™, HTC™, Huawei™, IBM™, Kyocera™, LG™, Motorola™, NEC™, Nokia™, Palm™, Panasonic™, Pantech™, RIM™, Samsung™, Sanyo™, Siemens™, Sony Ericsson™, Toshiba™, UTStarcom™, etc., or any other manufacturer of any other type of mobile device.

Plug and socket connections also include the most common five plug and socket designs found in the EIAJ standard RC-5320A (a.k.a. JEITA RC-5320A): EIAJ-01 is used for 0-3.15V charging, EIAJ-02 or EIAJ RC-5321 are used for for 3.15-6.3V charging, EIAJ-03 is used for for 6.3-10.5V charging, EIAJ-04, EIAJ RC-5322 or ARINC 628/EmPower connector are used for for 10.5-13.5V (a.k.a. JSBP 4) charging, and EIAJ-05 is used for for 13.5-18 V (a.k.a. JSBP 5) charging. The RC-5321 and RC-5322 are used for 12V and 24V applications. Two different national standards exist, EIAJ in Japan and DIN in Germany. The cable connection may also include a removable electricity connecting means 210.

18V DC to 20V DC power are required by many notebook computers. The Apple™ PowerBook requires 24V DC. Apple™ USB chargers have 4 pins and provide +5V volts on pin 1 and a ground on pin 4. Pins 2 and 3 in a USB socket are for data. Apple™ products (iPhone 3G or 3GS) require current from the 2 and 3 pins to charge a device. An Apple™ USB charger outputs 2V and 2.7V on pins 2 and 3 of the USB socket. A modified USB charging plug or socket is needed for some Apple™ products.

Another embodiment includes a splitter plug (not shown) with at least two outlet socket port 140 ends with an illumination source 155 directionally located on or in the housings which can be turned on or off with switches 150.

The cigarette lighter plug 220 comprising a first electricity contact tip 130 and second electricity contact springs 135 for insertion into a cigarette lighter socket power supply accepts 12V DC and 24V DC power, with short circuit overload protection for 10V DC-28V DC of current, by using an intelligent CPU inside the cigarette lighter plug 220 housing having the ability to distinguished a battery's polarity and change it.

Another embodiment includes the cigarette lighter plug 220 comprising a first electricity contact tip 130 and second electricity contact springs 135 for insertion into a cigarette lighter socket power supply also functions as a digital voltmeter for measuring the voltage output of the cigarette lighter socket. The illuminated digital display 230 shows the exact battery voltage and charging voltage from 0V-28V DC. The cigarette lighter plug 220 can be connected to an external power source for charging or maintaining the charge of a battery. This embodiment protects the engine's computer and accessories power surges that occur when jump starting or quick charging a car's, truck's, boat's, etc. battery. The illuminated digital display screen 230 can displays the voltage supplied to the battery and the battery's charge level. Reducing the output voltage of the cigarette lighter plug 220 to zero or maximum voltage, or a using a secondary switch (not shown), displays the battery voltage or charging voltage.

A traveler without an AC charging cord, could charge their computer using another computer using the detachable cable 115 with electrical connectors 210 on either end by attaching 12V FireWire charging plugs to both ends of the detachable cable 115 and connecting both computers together or by connecting the computers together using the battery charging sockets. Using a second detachable cable 115 with a 5V USB or 5V HDMI charging tip on one end and a cell phone charging tip on the other end would allow the traveler to charge their cell phone simultaneously. The 12V FireWire charging plug end may also include a voltage regulator (not shown).

A hiker or an individual in a remote location, could use the detachable cable 115 to charge a mobile device while hiking by plugging the charging tip into their mobile device and placing it in their backpack and connecting the other end of the detachable cable 115 to a 5V solar charging panel attached to the top of their backpack or a second backup battery pack. Multiple voltage solar charging panels or a voltage regulator enables the user to charge any device. At night the hiker could use the detachable cable 115 with the illumination source 155 on one end with a LED flashlight 40 plugged in connected to a mobile device or a second battery backup pack on the opposite end for powering the illumination source 155 and LED flashlight 40.

The plug end of a plug charging tip can only be inserted into a device's charging socket one way, with the illumination source 140 and on/off switch 150 on top, which will prevent the user from continually trying to figure out which way the charging tip is inserted into their device for powering or charging the device. This feature alone is extremely advantageous for the user.

Connecting the outlet port with an illumination source 140 end to a prior art suction cup (not shown) or refrigerator magnet clip (not shown) with an embedded magnet, a hook and loop fastener, commonly known in the art as Velcro™, or other fastening means (not shown) allows the outlet port with an illumination source 140 end to be clipped on a car visor, attached to the side of a car while changing a flat, or positioned for any other action that requires the user to direct a hands free light source to where it is needed. Plugging in a second illumination source 40 increases the amount of illumination produced.

Another embodiment of the present invention includes replacing or connecting the outlet socket port with an illumination source 140, with a specific battery charger housing or a multi-battery charger housing (not shown) for charging 1.5V AA or 1.5V AAA batteries, lithium ion batteries (4.1V-4.2V), lithium polymer batteries (4.3V-4.4V), nickel cadmium batteries (1.5V), nickel metal hydride batteries (1.2V-1.5V), etc. used in cameras, video equipment, handheld games, mobile devices, toys, etc. The battery charger housing preferably includes a secondary illumination source to notify the used when the charger is powered and when the charge cycle is completed The 1.5 AA battery charger includes an adapter to accept the shorter 1.5V AAA battery.

All new cell phones or mobile devices could be sold with the previously described cigarette lighter charger 100 or 200 having a cable 110 with a cigarette lighter plug 120 comprising a first electricity contact tip 130 and second electricity contact springs 135 for contact to a power supply on one end and an outlet socket port 140 with an illumination source 155 which can be turned on or off with a switch 150 on an opposite end, the cell phone's or mobile device's charging plug and an AC plug with a 12V or 24V power cigarette lighter socket. This would provide both AC voltage and DC voltage powering and charging options, a portable illumination source and the ability to always insert the charging tip into the cell phone or mobile device with the correct orientation on the first attempt. An individual could use an old unused cell phone or mobile device cigarette lighter charger 100 or 200 as a second charging cord by replacing the charging tip. This would stop the manufacturing of unnecessary secondary chargers, the resources to manufacture them and would help to reduce garbage in landfills.

While the present invention disclosed has been described with reference to the preferred embodiments thereof, a latitude of modification, change, repositioning of elements, relocation of elements, and substitution is intended in the foregoing disclosure and drawings, and in some instances, some features of the invention will be employed without a corresponding use of the invention's other features. Accordingly, it will be appreciated by those having an ordinary skill in the art that the above description is only illustrative of specific embodiments and examples of the invention. Various modifications and variations can be made to the present invention, and it is appropriate that the description and appended claims are construed broadly and in a manner consistent with the true spirit and scope of the invention herein, without departing from the spirit and scope of the invention as a whole. The present embodiments are to be considered in all respects as illustrative and not restrictive, and all changes or modifications coming within the meanings and equivalency ranges of the appended claims are intended to be embraced therein. The accompanying claims are intended to cover such modifications, as they would fall within the true scope and spirit of the present invention.

1. A charging cord comprising:
a conductive cable with at least two wires;
a plug end for connecting to a power supply disposed on a first end of said cable;
a socket end for receiving a plug disposed on a second opposite end of said cable;
wherein said socket end comprises at least one illumination source on or in a socket end housing.

2. The charging cord of claim 1, wherein said illumination source comprises at least one light emitting diode.

3. The charging cord of claim 1, further comprising a switch located on said socket end housing for turning said at least one illumination source on or off.

4. The charging cord of claim 1, wherein said at least one illumination source is powered by an internal power supply.

5. The charging cord of claim 1, wherein said plug end comprises a voltage regulator for adjusting the voltage transmitted to said socket end.

6. The charging cord of claim 1, wherein said plug end comprises a display on an outer housing for showing said voltage transmitted to said socket end.

7. The charging cord of claim 1, wherein said conductive cable with at least two wires is enclosed in a retractable housing.

8. The charging cord of claim 1, wherein said socket end is connected to a magnetic spring clip using a hook and loop fastening means.

9. The charging cord of claim 1, wherein said socket end for receiving a plug receives a plug with at least one charging tip.

10. The charging cord of claim 1, wherein said socket end for receiving a plug receives a plug with at least one socket.

11. A charging cord comprising:
a conductive cable with at least two wires wherein both ends comprise an electrical connecting means;
a plug end for connecting to a power supply detachably disposed on a first end of said cable;
a socket end for receiving a plug detachably disposed on a second opposite end of said cable;
wherein said socket end comprises at least one illumination source on or in a socket end housing.

12. The charging cord of claim 11, wherein said illumination source comprises at least one light emitting diode.

13. The charging cord of claim 11, further comprising a switch located on said socket end housing for turning said at least one illumination source on or off.

14. The charging cord of claim 11, wherein said at least one illumination source is powered by an internal power supply.

15. The charging cord of claim 11, wherein said plug end comprises a voltage regulator for adjusting the voltage transmitted to said socket end.

16. The charging cord of claim 11, wherein said plug end comprises a display on an outer housing for showing said voltage transmitted to said socket end.

17. The charging cord of claim 11, wherein said conductive cable with at least two wires is enclosed in a retractable housing.

18. The charging cord of claim 11, wherein said socket end is connected to a magnetic spring clip using a hook and loop fastening means.

19. The charging cord of claim 11, wherein said socket end for receiving a plug receives a plug with at least one charging tip.

20. The charging cord of claim 11, wherein said socket end for receiving a plug receives a plug with at least one socket.
